(19) United States
(12) Patent Application Publication
(10) Pub. No.: US 2005/0123125 A1
(43) Pub. Date: Jun. 9, 2005

(54) Automated telephone dialing assistance module

(76) Inventors: Jahn J. Stopperan, Lakeville, MN (US); David Neuman, Randolph, MN (US)

Correspondence Address: Mark J. Burns, Esq.;HAUGEN LAW FIRM PLLP, 121 South Eighth Street, #1130, Minneapolis, MN, 55402, US

(21) Appl. No.: 10/983,073

(22) Filed: Nov. 4, 2004

Related U.S. Application Data
(60) Provisional application No. 60/517,200, filed on Nov. 4, 2003.

(51) Int. Cl. H04M 15/00; H04M 3/00

(52) U.S. Cl. 379/355.01

(57) ABSTRACT

The present invention provides an automated telephone dialing assistance module configured to be coupled with an existing telephone and to be incorporated with a telephone land line. A series of audio tags are programmable therein with an associated telephone number. The audio tags may be scrolled through using the module, and played over the speaker of the telephone. When a preselected audio tag is played, a dial button actuates the dialing of the associated telephone number. The module also allows audio tags and associated telephone numbers to be added and/or deleted.

### CROSS REFERENCE TO RELATED APPLICATIONS

This application claims priority from U.S. provisional patent application Ser. No. 60/517,200 filed on Nov. 4, 2003 and entitled “Audio Dialer”, the content of which is herein incorporated by reference in its entirety.

### FIELD OF THE INVENTION

The present invention relates generally to the field of automatic dialing telephones. More specifically, the present invention relates to a module for connecting to and providing automated dialing and audible call recipient databasing capabilities to existing telephones.

### BACKGROUND OF THE PRIOR ART

With each advance in technology, additional features and functions continue to be added to telephone systems. One such feature is that of providing automatic dialing capabilities to a telephone system.

There exists in the prior art a number of telephones having automated dialing capabilities. One such telephone dialer is described in U.S. Pat. No. 4,277,651, issued to Fisher, II et al., on Jul. 7, 1981. Each telephone number is stored in a preselected memory location and can be dialed by pressing a key or series of keys associated with the preselected memory location. A problem with this system is that a user must separately document and/or memorize which key is associated with a particular telephone number.

To overcome these problems, U.S. Pat. No. 6,320,957, issued to Draganoff on Nov. 20, 2001, discusses a method of storing and displaying telephone numbers using a textual display, identifying the person(s) associated with the telephone number. A problem with such a system is that it can be cumbersome to program the telephone numbers and corresponding textual identifiers into the dialing system. Additionally, such a system is ineffective for visually impaired persons, or persons that have physical or mental restrictions making them unable to physically use a traditional telephone keypad dialing system.

U.S. Pat. No. 6,507,729, issued to Cheng on Jan. 14, 2003, provides a voice activated telephone dialer. A user is able to verbally announce the name of the person they wish to call, triggering the dialing of the corresponding telephone number.

The Wisconsin Council of the Blind provides yet another voice activated telephone dialer, the XX-100 Voice Activated In-line Telephone Dialer. This device is a voice recognition unit that can be connected to an existing land line telephone system. The user lifts the handset and speaks the name or identifier, and upon recognition, the telephone dialer will dial the corresponding telephone number.

Although voice activated telephone dialers provide a convenient dialing system, it is cumbersome to set up the system, and the technology of existing voice recognition programs can be cost prohibitive, and may not always operate or perform as desired, for example due to individual voice pattern variations or background noise.

U.S. Pat. No. 5,481,595, issued to Ohashi et al. on Jan. 2, 1996, discusses a telephone having a voice tag dialing mechanism. The phone incorporates this feature as a part of the functionality of an existing mobile telephone, allowing a user to scroll through a listing of telephone numbers via an audio tag indicating the associated telephone number. Once the audio tag relating to the telephone number being sought is found, a single button is pressed to dial the associated telephone number. This reference requires the dialing mechanism to include a speaker and microphone system therewith. A problem with this integrated system, is that it requires the user to purchase an entirely new phone system, and thus, lacks the features and functions necessary to be incorporated into an existing phone.

With each advance in technological capability, new functions and features continue to be added to telephones, such as, the capability of modern cellular phones to provide access to the internet, and to be used as a digital camera, as shown in U.S. Design Pat. No. D466,096 issued to Takada on Nov. 26, 2002.

Although any number of new features are demanded by certain demographics, other demographics are unable and/or unwilling to adopt these new technologies due to the learning curve required to attain proficiency and/or the fact that they have no need for these additional functions. In particular, individuals with physical or mental limitations such as a person of limited sight or other such frailty, would benefit from a simplified dialing system that overcomes these problems of the prior art.

A person simply interested in an automated dialing system may be required to purchase an entirely new telephone having a number of unnecessary features. It would therefore be advantageous to provide a module that connects to an existing telephone system, allowing a user to automatically store and dial telephone numbers using their existing phone.

It would further be advantageous to provide a module that can be connected to a land telephone line so as to enable direct calling on an existing land line telephone system.

It would also be advantageous to provide a module having an automated dialing system that solves these and additional problems discussed with regards to the prior art.

### SUMMARY OF THE INVENTION

The present invention provides an dialing assistance module that is configured to be couplable to an existing telephone system. The dialing assistance module provides a system for storing telephone numbers and storing a plurality of corresponding audio tags therewith. The audio tags stored in the module are playable through an existing telephone system as identifiers for the telephone numbers corresponding therewith.

The present invention provides a simple automated dialing solution for connection to land line phones such as traditional and/or cordless telephone systems. The module preferably utilizes the speaker and microphone of the existing telephone system to which it is connected.

The module is programmable such that audio tags and corresponding telephone numbers may be added and deleted from the module.

Operation of the module includes a pair of scroll buttons, the depressing of which actuates the playing of sequentially stored audio tags. Each time that the scroll button is depressed, the next audio tag in the stored sequence is played. Once the audio tag associated with the predetermined telephone number is found, a dial button is depressed, causing the module to dial the corresponding telephone number via a series of corresponding dialing tones, after which the module shuts itself down to allow normal operation and connection of the telephone system.

The module is operated by activating a telephone receiver from a “standby” mode to an “on” mode and depressing one of the scroll buttons. The depressing of a scroll button actuates power to the module, and instructs the module to intercept and solely maintain a voltage signal across the outgoing telephone line that is consistent with the “standby” mode signal. The module then provides playback of an audio tag through the speaker system of the telephone. To dial a telephone number, the dial button is depressed causing the module to deliver the corresponding tones to the land line to which the module is connected.

When the module is in operational mode, the telephone system is temporarily disconnected from the land line and the phone preferably operates as the speaker and microphone for the module. Once the module has dialed the telephone number, the module reconnects the land line to the telephone, and returns to the “off” mode.

The various features and functions of this module provide a simple automatic dialing system that can be easily connected to an existing telephone system. The module functions by the regulation and control of the voltage going to a phone system. Modification of the module may be easily incorporated to correspond with the operating voltages of analog telephone lines of foreign countries, and to incorporate the module in a digital phone line.

The module may also be modified to be integrated within the housing of a telephone system, such that the functions and features are accessible in a single telephone unit.

These and other advantages are described in further detail with reference to the embodiments of the present invention.

### BRIEF DESCRIPTION OF THE DRAWINGS

FIG. 1 is a top perspective view of the present invention.

FIG. 2 is a rear perspective view of the present invention.

FIG. 3 is a block diagram of the present invention.

FIG. 4 is a block diagram of the present invention.

FIG. 5 is a schematic of the sound interface FIG. 6 is a schematic of the record/play FIG. 7 is a schematic of the memory FIG. 8 is a schematic of the phone interface FIG. 9 is a schematic of the power module FIG. 10 is a schematic view of an alternative embodiment of the power module from FIG. 9 FIG. 11 is an embodiment of the present invention incorporated in a telephone system.

### DETAILED DESCRIPTION OF THE PREFERRED EMBODIMENTS

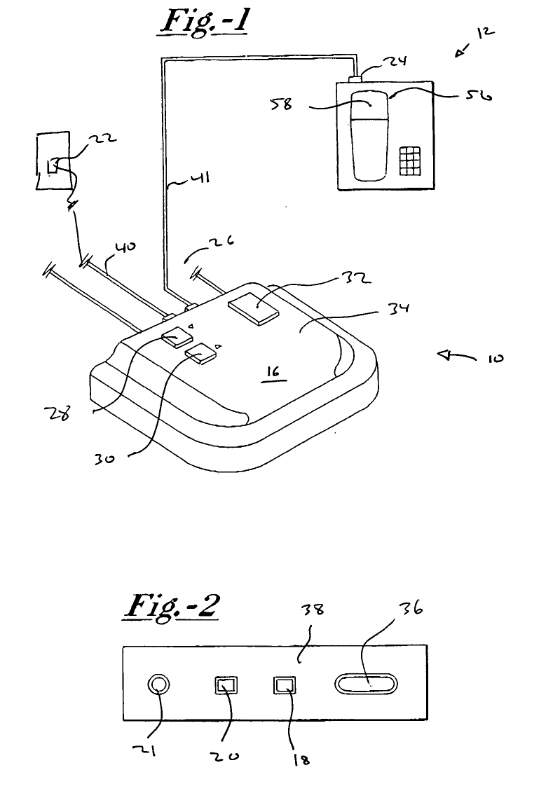

FIG. 1 illustrates a top view of an embodiment of the present invention. A dialing assistance module 10 is shown for connecting to an existing telephone handset system 12. The dialing assistance module 10 is configured for simple operation thereof. A control system 14 is contained within a housing 16 of the module 10. The back portion of the module 10, as shown in FIG. 2, provides communication ports 18, 20, 21, accessible through the housing 16 for coupling to a first phone jack 22, such as a wall phone line jack, a telephone system phone jack 24, and a wall outlet power source 26.

Operation of the module 10 is performed by interaction with the various buttons accessible through the housing 16, and electrically coupled to the control system 14. These buttons include a first scroll button 28, a second scroll button 30 and a dial button 32 positioned on the top section 24 of the housing 16. Also provided is a program button 36 accessible through a back portion 38 of the housing 16. Through module 10 is described above as utilizing buttons 28, 30, 32, and 36 for actuating various functions of control system 14, Applicants envision other actuation mechanisms which could be used in place of buttons 28, 30, 32, and 36. Such alternative actuation mechanisms include, for example, switches, touch-sensitive screen regions, and the like.

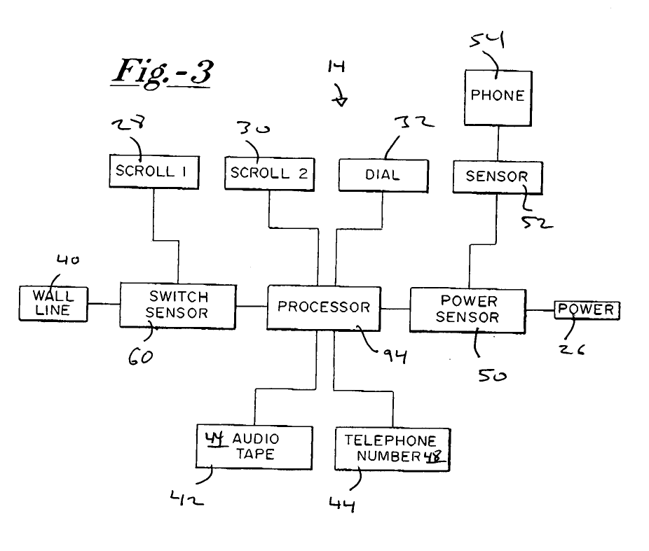

FIG. 3 provides a block diagram of the operation and control system 14 of the dialing assistance module 10. A first port 18 is couplable to a traditional phone line wall jack 22 via a phone line chord 40. A second port 20 is couplable to an existing telephone handset system 12 via a phone line chord 40. A power source port 21 is couplable to a wall outlet 26, by a power chord, for example. One or more portable power sources such as batteries may alternatively be utilized as a power source, and incorporated therein.

The control system 14 includes a first memory component 42 for storing a plurality of audio tags 44. The audio tags 44 may contain an audibly recorded name of a person or business, or may instead encompass some other type of audio identifier for an associated telephone number.

The control system 14 includes a second memory component 46 for storing a plurality of telephone numbers 48, each such telephone number 48 being associated with a corresponding audio tag 44.

The control system 14 of the module 10 includes a power sensor switch 50 such that the module 10 is remains in a power OFF mode until activated. In the OFF mode, the phone line voltage supplied by line 40 is passed through module 10 to phone system 12. Activation of the module 10 occurs when a sensor switch 52 coupled to the second port 20 senses that the telephone receiver 54 has been taken off the hook 56 or otherwise activated, providing a dial tone to the telephone receiver 54. The lifting of the receiver 54 provides a voltage to the second port 20, activating the sensor in the second port 20, which in turn activates the module 10 by opening a switch in the power port 21 allowing a voltage from the power source 26 to power the module 10.

The control system 14 switches the power sensor switch 50 to the ON mode only when one of the buttons 28, 30, 32, 36 is depressed, powering the module 10 by interrupting standard phone line voltage to the telephone line 24, and supplying a distinct electronic communication connection to the telephone system 12. The module 10 then provides a voltage to the telephone system 12, while simultaneously shutting off a sensor switch at the first port 18, thus shutting off communication with the telephone line to the wall telephone jack 22.

The telephone system 12 is therefore rendered operational only as a speaker and/or microphone and keypad entry while module 10 is in the “ON” mode, wherein the operation of the telephone speaker, microphone and keypad are powered by voltage from the module 10, but cut off from connection to the regular phone line.

The audio tags 44 and corresponding telephone numbers 48 are stored in a numbered sequence. When the module 10 is in the ON mode and the first scroll button 28 is depressed, a first audio tag 44 is audibly played by accessing the correspondingly sequenced audio tag 44 within the first memory component 42 and playing such audio tag 44 through, for example, the speaker 58 of the telephone system 12 via the telephone coupling line 41. When the first scroll button 28 is depressed a next time, the next audio tag 44 in the sequentially stored list is played from first memory component 42. The first scroll button 28 may be consecutively depressed and will eventually loop to the beginning of the audio tag list when the entire list has been scrolled through.

The second scroll button 30 may be depressed to play the audio tags 44 in reverse order in which the audio tags 44 are stored in memory component 42. For example, it will play the last audio tag 44 in the stored list first and then the second to the last audio tag 44 in the stored list upon subsequent depression of second scroll button 30. When the beginning of the list has been reached through this method, the second scroll button 30 may continue to be depressed and the list will loop to the end of the list.

When an audio tag 44 is played that corresponds to a predetermined telephone number 48 that the user wishes to utilize, the dial button 32 may be depressed to actuate the dialing of the stored telephone number 48 corresponding with the audio tag 44.

Any number of scrolling methods may be employed. For example, the first scroll button 28 or second scroll button 30 may be depressed any number of times in any order. Also, there may be additional features that allow the audio tags to be scrolled through by most recently called, or by most frequently called or any other such predetermined arrangement that can be programmed into the functionality of the module 10.

The module 10 may be packaged for a consumer with preprogrammed audio tags 44 and corresponding telephone numbers 48. In such case, the audio tags 44 may be recorded in a different voice, or in a different identifying manner than if they were recorded by the user of the module 10. Any audibly recognizable audio tag may be used, such as a chime, tone, series of sounds, spoken words or any other such identifier that is recordable.

The depressing of the dial button 32 causes the assisted telephone number 48 to be dialed by turning off the sensor switch 52 associated with the second port 20, thereby re-establishing connection between phone line 40 and telephone system 12, and further disconnecting the telephone system 12 from communication with the module 10. The module 10 provides a series of tones associated with the selected telephone number 48 to the first port 18, coupled to the wall jack line 22. Once the number has been dialed, the sensor switch 52 to the second port is opened and the power switch 50 is turned to the OFF mode such that the power to the module 10 is shut down. The telephone line 24 and telephone system 12 are in communication with each other via the connection between the first port 18 and second port 20, to allow normal operation of the telephone system 12.

Because the operation of the module 10 requires a sensor switch 52 at the second port 20, the proper coupling of the wall jack line 22 with the first port 18 and telephone system 12 with the second port 20 is required. A configuration switch 60 has been provided that allows the normal operation of the telephone system 12 if the phone line couplings are coupled in reverse to their intended port configuration. While, such switch 60, when activated, renders the module 10 inoperable when improperly configured, switch 60 enables module 10 to not interfere with the normal operation of the telephone system 12.

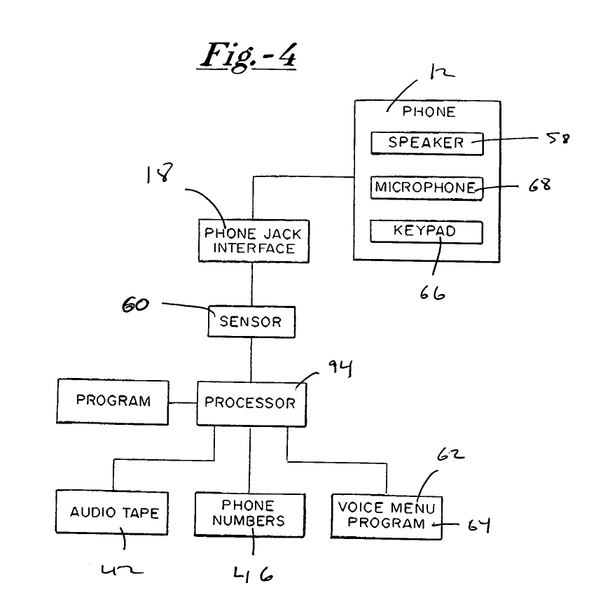

FIG. 4 provides a block diagram of the control system 14 for programming the use of the module 10. The program button 36 is depressed to access a third memory component 62 having an audio voice menu tree 64 stored therein. The control system 14 allows audio tags 44 and corresponding telephone numbers 48 to be added and/or deleted from their corresponding memory components 42, 46.

To add an audio tag 44 to memory component 42, and the corresponding telephone number 48 to memory component 46, the telephone 54 must be lifted off of the hook 56 or otherwise activated to provide a dial tone, and one of the buttons 28, 30, 32, 36 must be depressed, which activates the module 10. Once activated, the program button 36 may be depressed to initiate the voice menu tree 64. The voice menu tree 64 is coupled to the control system 14 to receive inputs from the keypad 66 of the telephone system 12. When the proper input from the keypad 66 is received, in accordance with the voice menu tree instructions, a user is prompted to record an associated audio tag 44. The audio tag 44 is recorded via the microphone 68 of the telephone system 12, and is stored in the first memory component 42. The audio tag 44 may be stored in a predetermined position in a list within the first memory component 42. Prior to recording the audio tag 44, the user may use the scroll buttons 28, 30 to select an audio tag 44 from the list. When the new audio tag 44 is recorded, it is preferably stored in the list position following the most recently played audio tag 44. When the audio tag 44 has been recorded, a preset time window is provided, after which the recording mode is automatically terminated in accordance with the voice tree menu.

Once the audio tag 44 is recorded, the user is prompted to enter the corresponding telephone number 48. The corresponding telephone number 48 is recorded by entering the number string on the keypad 66 of the telephone system 12. The telephone numbers 48 are stored within the second memory component 46 to correspond with the audio tag 44.

To remove an audio tag 44 and the corresponding telephone number 48, the user activates the voice menu tree 64 and follows the instructions therefore. The user selects the appropriate input using the keypad 66 of the telephone system 12. Once selected, the user is prompted to scroll through the audio tags 44 using the scroll buttons 28, 30. Once the associated audio tag 44 is played, the user presses a predetermined key on the keypad 66 to actuate the deletion of the audio tag 44 and corresponding telephone number 48 from the stored list.

To initiate the programming mode requires the same activation of the module 10 as does scrolling and dialing. The telephone receiver 54 must be taken off the hook 56, thus activating the module 10, and then one of the buttons 28, 30, 32, 36 must be depressed to turn the module 10 to the ON mode. Once in the ON mode, the telephone system 12 is powered by the voltage delivered thereto by the module 10. The module 10 disconnects the telephone system 12 from the telephone line, rendering the telephone system 12 operational only as a speaker, microphone and for keypad entry, and inoperable for dialing purposes.

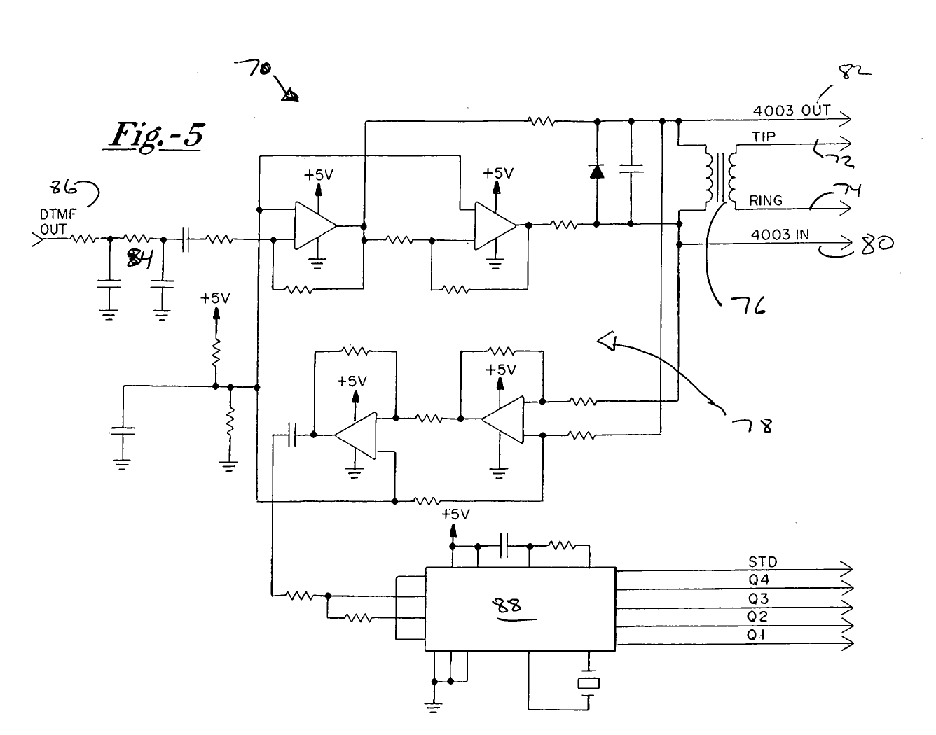

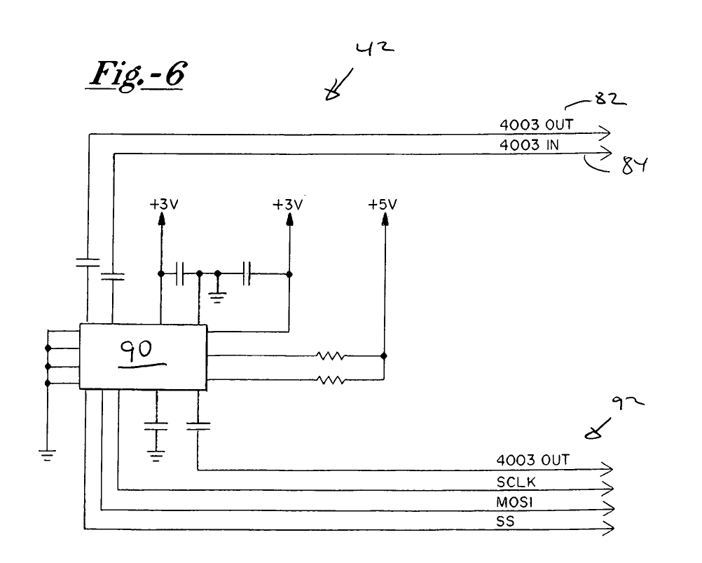

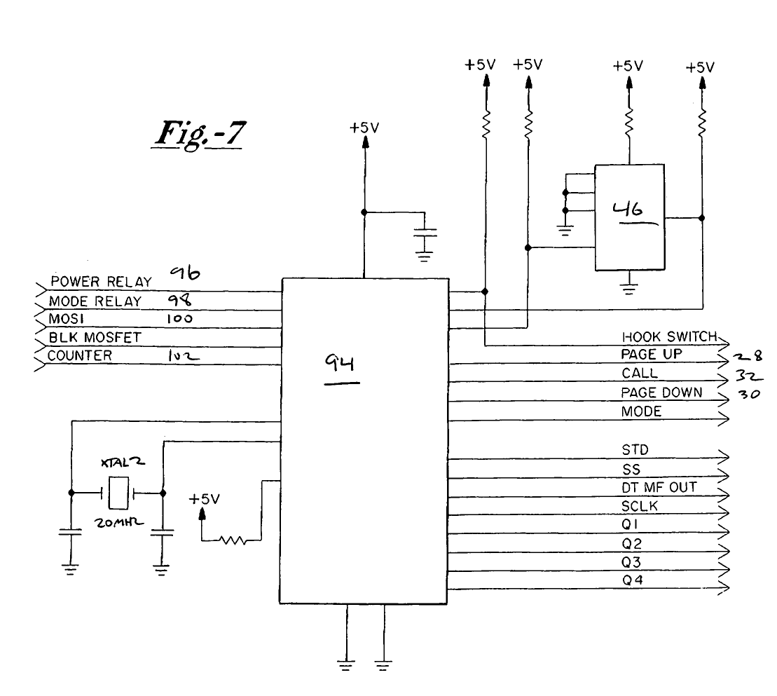

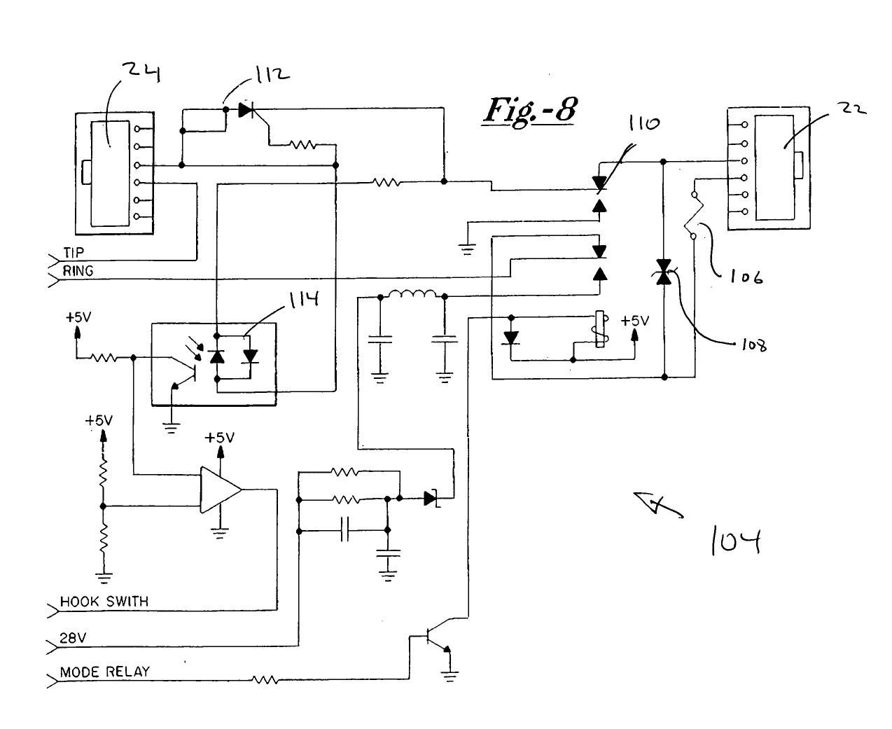

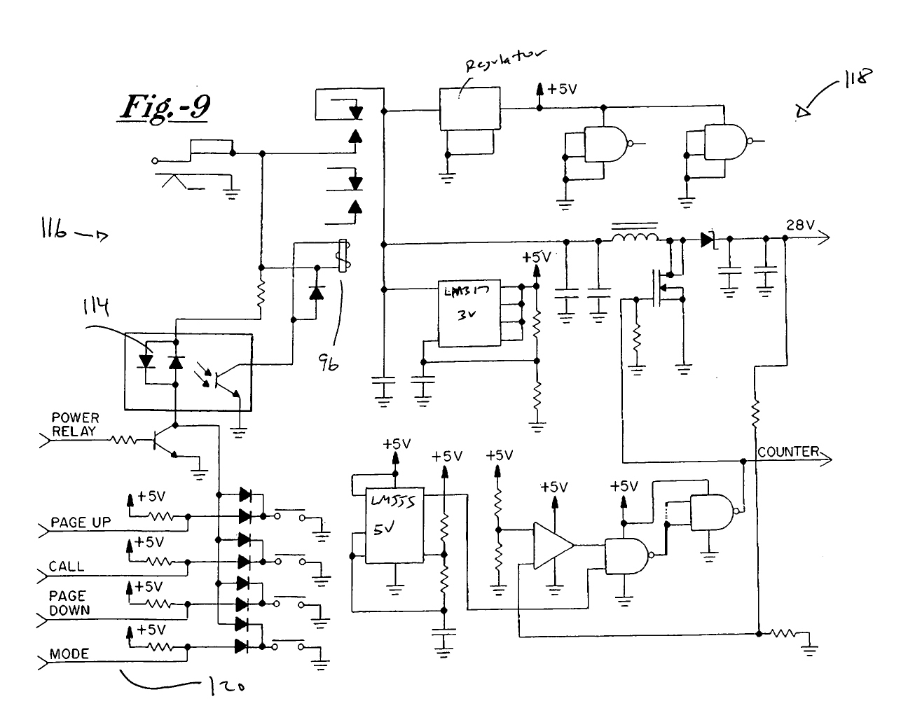

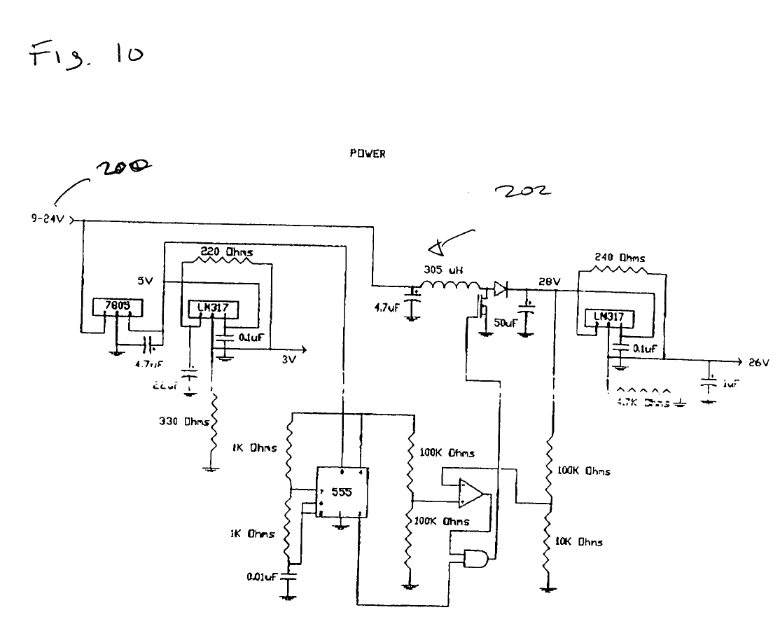

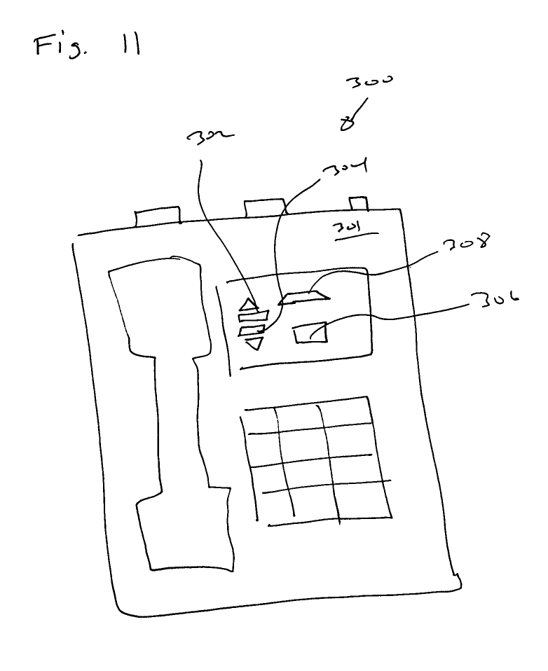

FIG. 5 is a schematic of the sound interface 70 in accordance with an embodiment of the present invention. The interface 70 has a tip sensor 72 and ring sensor 74 for detecting and delivering a voltage to the telephone system 12. An isolation transformer 76 in conjunction with an arrangement of transformers 78 provides a buffer from the external phone line voltage.

An audio input switch 80 is operable to allow the recording of a new audio tag using the microphone 68 of the telephone system 12 when coupled to the second port 20. An audio output switch 82 is operable to provide an output of an audio tag 44 through the speaker 58 of the telephone system 12 when coupled to the second port 20.

The outgoing dial tones for telephone numbers 48 corresponding with an associated audio tag 44 are provided by the two stage low pass filter 84 through the outgoing DTMF switch 86 which incorporates a built-in pulse width modulator. The pulses are controlled by the microprocessor 94, which operates the pulse width modulator to dial the telephone number 48 stored in the second memory component 46. When the dial button 32 is depressed, the second port switch 52 is closed, terminating communication with the telephone system 12. The tones associated with the telephone number 48 are delivered to the telephone line 22 via the coupling at the first port 18.

When the telephone keypad is utilized to record a new telephone number, the decoder 88 allows the tones from the keypad to be decoded and stored in the second memory component 46.

FIG. 6 provides a schematic view of the first memory component 42 for storing and accessing the audio tags 44. An analog recording chip 90 is shown, capable of receiving an audio input, storing and allowing access and retrieval of the audio input. Also shown is an SPI 92 under the control of the microprocessor 94. The first memory component 42 is a flash memory unit such that information remains stored therein even when power is no longer supplied to the first memory component 42.

FIG. 7 provides a schematic of the microprocessor 94 in accordance with an embodiment of the present invention. The microcontroller 94 is a flash memory device connected to a power relay 96. The power relay 96 is a latched relay to turn the module 10 on or off. A mode relay 98 provides a switch for providing power to the telephone system 12. Also shown are a MOSI 100 and blocking MOSFET 102.

The hook switch 52 includes a sensor to sense whether the telephone system 12 is on or off, based upon whether the hook 56 has been lifted, or remains in place, respectively. The second memory component 46 is shown as a flash memory chip for storing the telephone numbers 48 and coordinating with the voice chip via a linked list to a corresponding audio tag 44. The scroll buttons 28, 30, dial button 32 and program button 36 also link to the processor 94 as do the switches necessary to decode the tones associated with a telephone number 48 for outgoing dial tones.

FIG. 8 provides a schematic of a phone interface 104 in accordance with an embodiment of the present invention. The first port 18 is connected to a fuse 106 and voltage suppressor 108 in accordance with standard safety requirements. A 5V relay 110 is provided to generate 28V of internal power to the telephone system 12 when the module 10 is in use.

Turning now to the second port 20, a hook switch 52 is provided, having a sensor such that if the telephone system 12 is not in operation, no power is provided to the module 10. When the telephone system 12 is lifted or otherwise activated, and thus off the hook, the sensor switch 52 is turned on, to provide power to the module 10 via the 5V relay 110, so as to mimic an ON mode for the telephone system 12, despite the telephone system being disconnected from the telephone line by the module 10.

Also shown is a sensor 112 and opto-isolator 114, configured such that if the phone lines 40, 41 are switched so as to be coupled to the wrong phone jacks 22, 24, the module 10 will remain in an OFF mode, and be inoperable so as to avoid problems with the operation of the telephone system 12 yet allows the telephone signal to pass through the module, allowing the telephone system to operate properly. The sensor 112 indicates to the opto-isolator 114 to allow voltage to pass through the phone interface 104, while keeping the module 10 in the OFF mode and providing a normal signal and operational capability to the phone system 12.

This configuration also allows operation of the module 12 when the polarity of the voltage from the telephone line coming from the wall jack 22 is reversed. The phone interface 104 will correct the voltage polarity to provide proper operation thereof.

FIG. 9 provides a schematic of a power module 116 in accordance with an embodiment of the present invention. Each of the buttons, the scroll buttons 28, 30, the dial button 32 and program button 36, are coupled to switches. When the module 10 has been powered on, by sensing that the handset has been taken off the hook, then depressing any of the buttons will switch power the module 10 to the ON mode via the opti-isolator 114, by firing a relay 110. The relay 110 then provides voltage to a boost circuit 118 to energize the telephone system 12 connected to the module 10, and the first memory component 42 and the second memory component 46. Regulator 119 of the boost circuit 118 transposes input voltage from the power source 26 of module 10 into the standard voltage required by operably coupled phone system 12. The telephone system 12 then operates as a speaker system for playing the audio tags 44, and is disconnected from communication with the telephone line 22. The power module 116 may also have a timer 120, such that when the power module 116 is in the ON mode by sensing the telephone system 12. For example, a module 10 having a remote wall power source input of 110 volts preferably transposes such input voltage to a 28 volt output, which is the standard for phone systems operated in the United States. Moreover, regulator 119 may instead ramp up output voltage from, for example, a portable power source having a voltage of less than the required output voltage. A particular example may be in the case of a 9 volt battery portable power source to module 10, where in regulator 119 modifies the input voltage of 9 volts to the required output of 28 volts.

Regulator 119 of the present invention may also be programmed to provide a predetermined output voltage that is compatible with the standard phone system operating voltage of the associated country or region into which the system of the invention is being utilized. As such, the output voltage provided by regulator 119 may not be 28 volts in order to be compatible with the associated phone system. In addition to voltage variability's encountered by different operating standards around the world, digital and/or multiple user phone systems may have unique operating voltage requirements. Accordingly, it is an aspect of the present invention to provide a modifiable regulator 119 that has the capability of transposing various input power voltages into desired output voltages. The telephone system 12 then operates as a speaker system for playing the audio tags 44, and is disconnected from communication with the telephone line 22. The power module 116 may also have a timer 120, such that when the power module 116 is in the ON mode by sensing the telephone system 12 is off the hook 56, and activated by depressing one of the buttons, the power module 116 will remain powered only for a predetermined period of time, such as about 20 seconds, after which it will power down, if no input has been received within the predetermined amount of time.

FIG. 10 shows an alternative embodiment of the present invention wherein a battery may be utilized as the power source for the module. In this embodiment, the battery power must be amplified to provide the necessary voltage to the telephone system connected thereto, for use of the telephone system as the speaker and/or microphone. The embodiment shown utilizes a battery power input 200 and a circuitry configuration 202 supplying a predetermined voltage to the module and/or to the telephone system, in accordance with the operation of the module discussed with reference to FIGS. 1-9, above.

FIG. 11 shows an alternative embodiment of the present invention wherein the functional features of the module are incorporated into an existing telephone system 300. The first scroll button 302, second scroll button 304 are shown to be accessible through the housing 301, to scroll through the audio tags that are actuated thereby. A dial button 306 is also shown extending through the housing to allow actuation of the dialing mechanism. The program button 308 is also accessible through the housing to allow access to the voice tree menu for adding and deleting information from the database of audio tags and telephone numbers. The module is incorporated into an existing phone, and operates in conjunction with the telephone system as described with reference to FIGS. 1-9.

It is further contemplated that the module 10 may be utilized with digital telephone systems with only minor modifications, such as the incorporation of an analog/digital converter, or designing a digitally operated module. A voltage booster system may also be necessary to make up for any discrepancies in the line voltage of a digital system.

Additionally, it is contemplated that the first memory component and second memory component may, instead, be embodied in a removable memory card. The module would include a mating slot for receiving the removable memory card and communicating therewith to access audio tags and telephone numbers stored in the removable memory card.

It is further contemplated that the module may include a remotely storable and loadable database, allowing telephone numbers and audio tags to be programmed from a remote location, such as a telephone system that is not directly connected to the module. In such an embodiment, the module may include a modem with which remote communication is enabled for accessing and utilizing the module.

It is also contemplated that the module may be utilized as an electronic rolodex and/or address book wherein additional information may be stored therein to correspond with an audio tag and telephone number.

The invention has been described herein in considerable detail in order to comply with the patent statutes, and to provide those skilled in the art with the information needed to apply the novel principles and to construct and use embodiments of the invention as required. However, it is to be understood that the invention can be carried out by specifically different devices and that various modifications can be accomplished without departing from the scope of the invention itself.

1. An automatic dialing system comprising:
a) a first memory storage component for storing an audio tag;
b) a second memory storage component for storing a telephone number corresponding with said audio tag;
c) a selector component for accessing said audio tag;
d) a dialing component for accessing said telephone number and producing a series of dialing tones corresponding to said telephone number.
e) a port for coupling to a telephone system.

2. The automatic dialing system in accordance with claim 1, further comprising a switch coupled to said port.

3. The automatic dialing system in accordance with claim 2 wherein said switch is in an OFF configuration when said series of dialing tones are dialed.

4. The automatic dialing system in accordance with claim 3 wherein said switch is in an ON configuration after said series of dialing tones are dialed.

5. The automatic dialing system in accordance with claim 4 wherein said automatic dialing system is connected to a power source.

6. The automatic dialing system in accordance with claim 5 wherein a power switch maintains said power source in an OFF configuration until an off-hook signal is received from a telephone line.

7. The automatic dialing system in accordance with claim 6 wherein said power source switch is in an OFF configuration after said telephone number is dialed.

8. A module for connecting to a telephone system comprising:
a) a housing for a control system;
b) a first port for connecting to a telephone line;
c) a second port for connecting to a telephone system;
d) a power source;
e) a control system capable of storing a plurality of audio tags and a plurality of corresponding telephone numbers therein;
f) a scroll button for accessing an audio tag from said plurality of audio tags and actuating said audio tag to be played over said telephone system; and
g) a dial button for accessing one of said corresponding telephone numbers corresponding with audio tag.

9. The module according to claim 8 wherein said audio tags and said plurality of corresponding telephone numbers are stored on a removable memory card.

10. The module according to claim 8 wherein said power source is a battery.

11. A telephone system comprising:
a) a housing;
b) a scroll button accessible through said housing for accessing an audio tag and playing said audio tag over a speaker system of said telephone system;
c) a dial button accessible through said housing for accessing a telephone number corresponding to said audio tag; and
d) a processor for providing a series of outgoing dial tones associated with said telephone number.

12. A component for operably interfacing with a land-line telephone, comprising:
a) a power inlet for receiving power from a power source;
b) a power outlet for transmitting power to said telephone;
c) a phone line intersection operably coupled to a phone line that is operably coupled to said telephone;
d) a control system for selectively activating said phone line intersection, thereby disconnecting said phone line from said telephone, said control system automatically directing said power from said power source to said telephone at a predetermined voltage level consistent with designated power requirements of said telephone upon activation of said phone line intersection.

13. A component as in claim 12, including one or more memory elements operably storing one or more telephone numbers and one or more audio tags associated therewith.

14. A component as in claim 13 wherein said control system includes a user selection mechanism for selectively audibly retrieving said one or more audio tags from said one or more memory elements.

15. A component as in claim 14, including call execution means for selectively generating and transmitting dial tones through said phone line, which dial tones correspond to said telephone numbers associated with selected ones of said audio tags.
